(19) United States
(12) Patent Application Publication
(10) Pub. No.: US 2024/0257028 A1
(43) Pub. Date: Aug. 1, 2024

(54) SYSTEMS AND METHODS FOR ROUTE OPTIMIZATION

(71) Applicant: Walmart Apollo, LLC, Bentonville, AR (US)

(72) Inventors: Zheqi Zhang, San Ramon, CA (US); Siddhartha Maheshwary, Brookhaven, GA (US); Minhao Liu, Sunnyvale, CA (US); Ti Zhang, Rocklin, CA (US); Jing Huang, San Jose, CA (US); Mingang Fu, Palo Alto, CA (US)

(73) Assignee: Walmart Apollo, LLC, Bentonville, AR (US)

(21) Appl. No.: 18/103,205

(22) Filed: Jan. 30, 2023

(51) Int. Cl. G06Q 10/083; G06Q 10/0631; G06Q 10/067

(52) U.S. Cl. CPC G06Q 10/067; G06Q 10/06311

(57) ABSTRACT

Systems and methods including one or more processors and one or more non-transitory computer readable media storing computing instructions that, when executed on the one or more processors, cause the one or more processors to perform: receiving workload information corresponding to a workload, driver information corresponding to drivers, and one or more constraints; building a coordinate system based on the workload information, the driver information and the one or more constraints; analyzing the coordinate system to determine a respective efficiency metric for each driver of the drivers for the workload; identifying a driver of the drivers in which the respective efficiency metric for the driver satisfies an efficiency metric threshold; and assigning the workload to the driver to reduce driver workload waste. Other embodiments are disclosed.

### TECHNICAL FIELD

This disclosure relates generally to computing system management, and more particularly to systems and methods for route optimization.

### BACKGROUND

At least some known systems and industries provide delivery services to their customers. For example, some companies in various industries provide the delivery of goods to their customers, such as the delivery of grocery items by grocers. In particular, the delivery of grocery items has increasingly become a method by which consumers obtain their grocery needs. To deliver goods, many of these companies employ delivery systems that include delivery vehicles. The delivery systems may include the scheduling and assignment of delivery orders to delivery vehicles. For example, a customer that purchases grocery items online may have the grocery items delivered to their home in a delivery vehicle.

These delivery vehicles, however, impose various costs on companies. For example, there are costs associated with purchasing or renting the vehicles, maintaining the vehicles, purchasing fuel for the vehicles, as well as employing drivers to drive the vehicles, just to name a few. In addition, delivery systems determine delivery routes and schedules for delivery trucks to deliver goods. The scheduling of the delivery of goods may also include the assignment of the goods to delivery vehicles for delivery. A delivery truck may receive a load assignment, for example, that includes the delivery of multiple orders. In addition, delivery systems may determine delivery routes that the delivery vehicles may travel to deliver ordered goods. As the number of delivery orders increase, the determination of load assignments and delivery routes, along with delivery costs, may increase as well. As such, there are opportunities to improve delivery systems and, in particular, to improve load and route assignments in a goods delivery system.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system that can be employed for detecting price anomalies, according to an embodiment;

FIG. 4 illustrates a flowchart for a method, according to certain embodiments;

FIG. 5 illustrates an exemplary coordinate system, according to certain embodiments;

FIG. 6 illustrates an exemplary coordinate system, according to certain embodiments;

FIG. 7 illustrates a flowchart for a method for performing a tabu search, according to certain embodiments;

FIG. 8 illustrates an exemplary system architecture, according to certain embodiments;

FIG. 9 illustrates an exemplary diagram showing the connection between the eight hour clock, eleven hour clock, fourteen hour clock, and seventy hour clock, according to certain embodiments;

FIG. 10 illustrates an exemplary output of a travel simulator, according to certain embodiments; and

FIG. 11 illustrates an exemplary output of a travel simulator, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and cause the one or more processors to perform: receiving workload information corresponding to a workload, driver information corresponding to drivers, and one or more constraints; building a coordinate system based on the workload information, the driver information and the one or more constraints; analyzing the coordinate system to determine a respective efficiency metric for each driver of the drivers for the workload; identifying a driver of the drivers in which the respective efficiency metric for the driver satisfies an efficiency metric threshold; and assigning the workload to the driver to reduce driver workload waste.

Various embodiments include a method. The method can be implemented via execution of computing instructions configured to run at one or more processors and configured to be stored at non-transitory computer-readable media. The method can comprise receiving workload information corresponding to a workload, driver information corresponding to drivers, and one or more constraints; building a coordinate system based on the workload information, the driver information and the one or more constraints; analyzing the coordinate system to determine a respective efficiency metric for each driver of the drivers for the workload; identifying a driver of the drivers in which the respective efficiency metric for the driver satisfies an efficiency metric threshold; and assigning the workload to the driver to reduce driver workload waste.

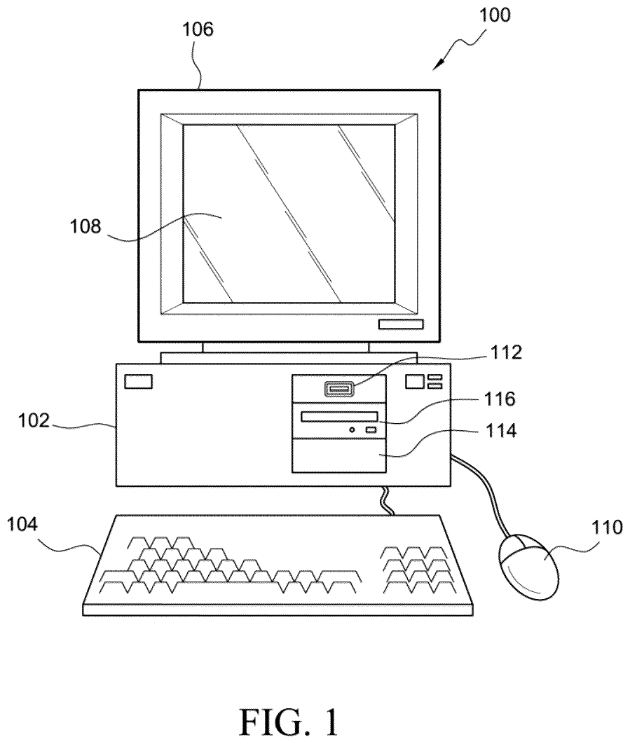

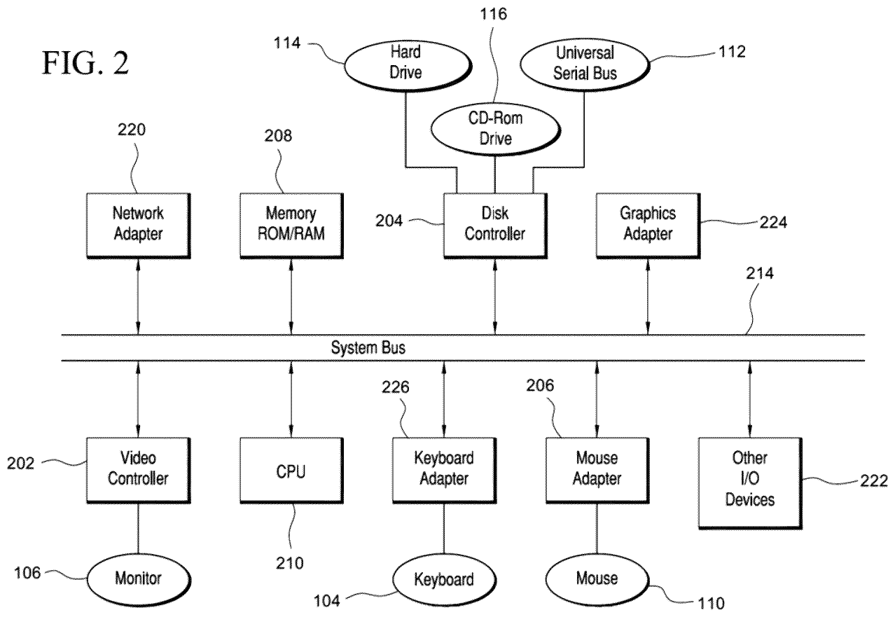

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

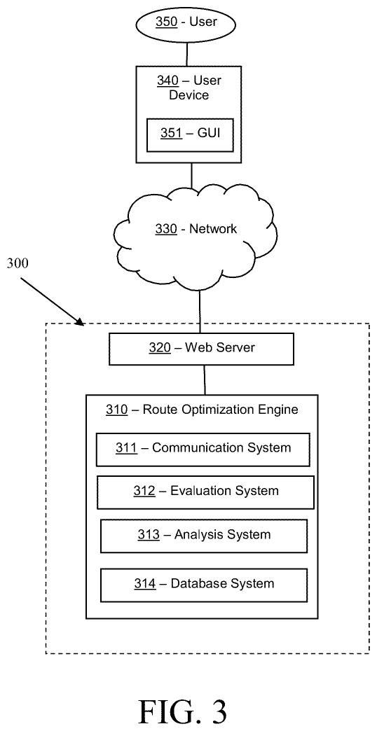

Turning ahead in the drawings, FIG. 3 illustrates a block diagram of a system 300 that can be employed for detecting price anomalies, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a route optimization engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Route optimization engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host route optimization engine 310 and/or web server 320. Additional details regarding route optimization engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with route optimization engine 310, in addition to other suitable activities. In a number of embodiments, web server 320 can interface with route optimization engine 310 when a user (e.g., 350) is viewing infrastructure components in order to assist with the analysis of the infrastructure components.

In some embodiments, an internal network that is not open to the public can be used for communications between route optimization engine 310 and web server 320 within system 300. Accordingly, in some embodiments, route optimization engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, route optimization engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to route optimization engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of route optimization engine 310 and/or web server 320. In a similar manner, the processors and/or the non-transitory computer-readable media can be local and/or remote to each other.

Meanwhile, in many embodiments, route optimization engine 310 and/or web server 320 also can be configured to communicate with one or more databases, such as a database system 314. The one or more databases can include workload information corresponding to a workload, driver information corresponding to drivers, constraints, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, route optimization engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, route optimization engine 310 can include a communication system 311, an evaluation system 312, an analysis system 313, and/or database system 314. In many embodiments, the systems of route optimization engine 310 can be modules of computing instructions (e.g., software modules) stored at non-transitory computer readable media that operate on one or more processors. In other embodiments, the systems of route optimization engine 310 can be implemented in hardware. Route optimization engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host route optimization engine 310 and/or web server 320. Additional details regarding route optimization engine 310 and the components thereof are described herein.

In many embodiments, user device 340 can comprise graphical user interface (“GUI”) 351. In the same or different embodiments, GUI 351 can be part of and/or displayed by user device 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user device 340. In the same or different embodiments, GUI 351 can comprise a website accessed through network 330. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user devices 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, route optimization engine 310, and/or web server 320 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of route optimization engine 310, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of route optimization engine 310, and/or web server 320. In a similar manner, the processing module(s) and the memory storage module(s) can be local and/or remote to each other.

In many embodiments, route optimization engine 310, and/or web server 320 can be configured to communicate with one or more user devices 340. In some embodiments, user devices 340 also can be referred to as customer computers. In some embodiments, route optimization engine 310, and/or web server 320 can communicate or interface (e.g., interact) with one or more customer computers (such as user devices 340) through a network 330. Network 330 can be an intranet that is not open to the public. In further embodiments, network 330 can be a mesh network of individual systems. Accordingly, in many embodiments, route optimization engine 310, and/or web server 320 (and/or the software used by such systems) can refer to a back end of system 300 operated by an operator and/or administrator of system 300, and user device 340 (and/or the software used by such systems) can refer to a front end of system 300 used by one or more users 350, respectively. In some embodiments, users 350 can also be referred to as customers, in which case, user device 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

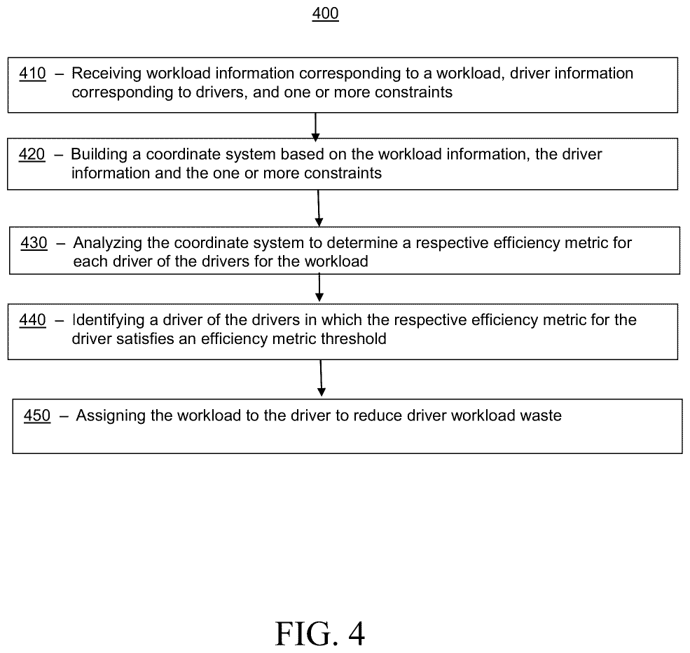

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as route optimization engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving workload information corresponding to a workload, driver information corresponding to drivers, and one or more constraints. In some embodiments, the workload information comprises: delivery information corresponding to when the workload needs to be delivered to a distribution center or a vendor, and a type of workload corresponding to at least one of the following: grocery, dry, pharmacy, third party, or federal emergency aid under FEMA. In some embodiments, the driver information comprises at least one of the following: 1) a driver type corresponding to at least one of the following: day-cab, weekly, or city, and 2) events associated with the driver. In some embodiments, the events include at least one of the following: training events, or personal events that effect the amount of workloads the driver can deliver on a day including an event. In some embodiments, the one or more constraints comprise at least one of the following: one or more drivers' union rules, local ordinance rules, and location exceptions for the workload (e.g., truck loads cannot be delivered between 9:00 PM-6:00 AM, workloads cannot exceed a specific weight limit, a perishable workload can only be transported between certain distribution centers/vendors, etc.).

In many embodiments, method 400 can comprise an activity 420 of building a coordinate system based on the workload information, the driver information and the one or more constraints. In some embodiments, building the coordinate system can include analyzing the workload information, the driver information, and the one or more constraints, and mapping the workload information, the driver information, and the one or more constraints in a three-dimensional grid corresponding to latitude in a y-axis of the three-dimensional grid, longitude in a x-axis of the three-dimensional grid, and time in a z-axis of the three-dimensional grid. In some embodiments, the coordinate system can include points for locations of the driver and when the driver will be available, points for the location of the workload and when the workload will be available, and points for the location of the destination for the workload and the window of time the workload needs to be delivered.

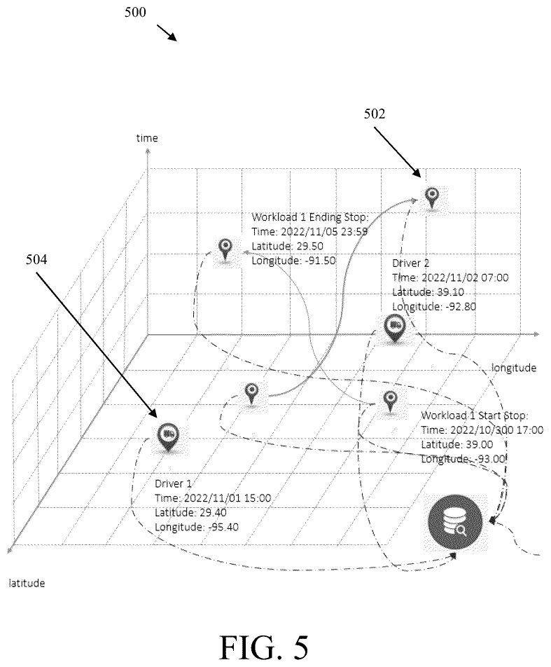

Turning briefly to FIG. 5, an example coordinate system 500 is illustrated. The coordinate system 500 maps drivers, workloads origin and destination (e.g., points) in the three-dimensional grid as detailed above. In some embodiments, points with similar time, latitude and longitude belong to the same cubic on the grid. The grid enables fast time and location based matching. In the illustrated embodiment of FIG. 5, the coordinate system 500 includes points 502 that correspond to either a starting position or an ending position for a workload and the corresponding coordinates for the starting position and the ending position. In the illustrated embodiment of FIG. 5, the coordinate system 500 includes points 504 that correspond to a time a driver will be available and the location the driver will be when the driver becomes available.

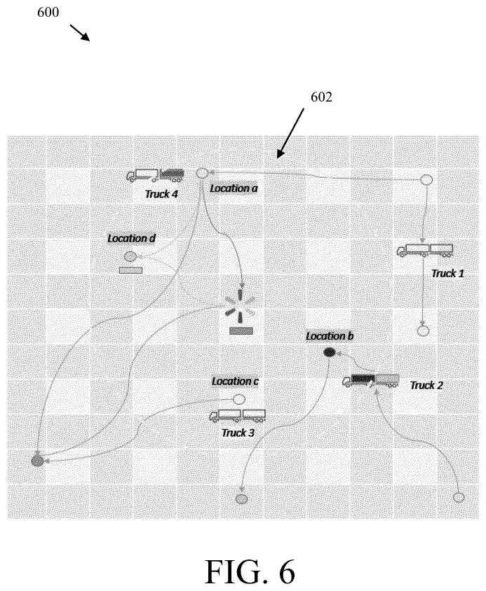

Returning to FIG. 4, in many embodiments, method 400 can comprise an activity 430 of analyzing the coordinate system to determine a respective efficiency metric for each driver of the drivers for the workload. In some embodiments, activity 430 can include identifying a threshold distance for the workload in the coordinate system. In some embodiments, activity 430 can include determining a positioning of a workload and identifying a search radius for potential drivers. Turning briefly to FIG. 6, an exemplary coordinate system 600 is illustrated. The coordinate system 600 of FIG. 6 corresponds to a three dimensional grid similar to the coordinate system 500 in FIG. 5. However, for ease of description the coordinate system 600 of FIG. 6 is illustrated as a two dimensional coordinate system. As shown in the illustrated embodiment of FIG. 6, the coordinate system 600 includes a candidate workload in the center of the search radius 602. Based on the search radius, activity 430 can determine that trucks 2, 3, and 4 are within a threshold distance of the workload and can be utilized in further analysis.

Returning to FIG. 4, activity 430 can include determining the respective efficiency metric for each driver of the drivers for the workload based on an equation comprising:

$$U ( w ) + P ( w ) + ( D ( w ) + W ( w ) + L ( w ) ) ,$$

where w corresponds to the workload, U(w) corresponds to an urgency of the workload, P(w) corresponds to a priority of the workload, D(w) corresponds to empty miles for each driver of the drivers picking up the workload compared to a current route, W(w) corresponds to a value based on a wait time for the workload on each driver of the drivers and a cost per minute of waiting corresponding to the workload, and L(w) corresponds to a value based on a time beyond a scheduled time of delivery for the workload and a cost per minute of being late for to the workload.

In some embodiments, determining the respective efficiency metric for each driver of the drivers for the workload can include analyzing the respective efficiency metric for each driver of the drivers for the workload by determining a regret metric using the following equation:

$$R ( w ) = n * max ( C ( w , d ) ) - sum of top n ( C ( w , d ) ) ,$$

where R(w) corresponds to a regret metric for the workload, d corresponds to a current driver being analyzed, and C(w, d)=D(w)+W(w)+L(w). In some embodiments, determining the respective efficiency metric can include determining the respective efficiency metric based on the regret metric using the following equation:

$$C ( w ) = R ( w ) + U ( w ) + P ( w ) .$$

In some embodiments, the efficiency metric threshold is a lowest value from among the respective efficiency metrics for the drivers. For example, a workload that needs to be delivered in 3 days can have an urgency of 300, and a workload that needs to be delivered today will have an urgency of 0. P corresponds to priority and is based on a ranking of the items in the workload. For example perishable items will have a higher priority (i.e., a lower cost) than non-perishable items. D corresponds to empty miles the driver will have to pick up the new workload compared to the drivers current route. This value is determined based on the amount of miles between workload destinations and the dollar cost per mile. W corresponds to a value based on the wait time for each workload on the drivers and the cost per minute of waiting corresponding to each workload. L corresponds to a value based on the time over the scheduled time of delivery (i.e., late) the workload is and the cost per minute of being late corresponding to each workload.

In one example, assume C=2 per mile. In this example, one driver has two candidate workloads. In this example, the above efficiency metrics can be determined as follows for workload 1 (W1) and workload 2 (W2): D(W1)=2*(300)+2*(150)=900; D(W2)=2*(300)+2*(200)=1,000 As such, workload 1 would be preferable because workload 1 has a lower efficiency metric than workload 2. In some embodiments, the efficiency metric is a cost to have the driver add this workload to their route.

In another example, assume C=2 per mile. In this example, activity 430 is determining where to insert workload 2.

For example, option 1 corresponds to inserting workload 2 before workload 1 and results in the following: D (W2, W1)=2*250+2*100+2*150=1000. Option 2 corresponds to inserting workload 2 after workload 1 and results in the following D (W1, W2)=2*300+2*100+2*120=1040. As such, inserting workload 2 before workload 1 is preferable because it results in a lower efficiency metric.

In many embodiments, method 400 can comprise an activity 440 of identifying a driver of the drivers in which the respective efficiency metric for the driver satisfies an efficiency metric threshold. For example, activity 440 can determine that the workload should be picked up by driver X because pairing the workload with driver X results in the lowest efficiency metric compared to the efficiency metrics of other drivers for the same workload.

In many embodiments, method 400 can comprise an activity 450 of assigning the workload to the driver to reduce driver workload waste. For example, the driver with the lowest efficiency metric is assigned the workload to reduce the costs associated with assigning the workload to another driver and to free up other driver resources.

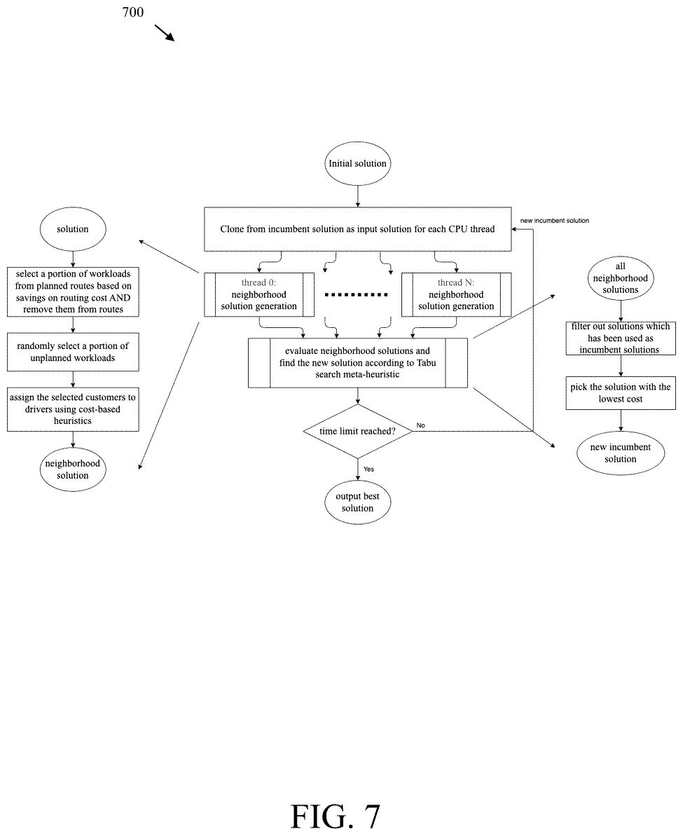

FIG. 7 illustrates an example flowchart for a method 700 for performing a tabu search. In some embodiments, the method 700 can start with an initial solution, which can be generated randomly or according a nearest neighbor algorithm. To create new solutions, for example, the order workloads are executed in a driver route can be modified and new unassigned workloads can be added to different driver routes to determine if another solution exists outside of the route that was determined to have the lowest efficiency metric in accordance with method 400 (FIG. 4). In some embodiments, the lowest efficiency metric is still utilized as a threshold to analyze the new routes. For example, once the time limit has been reached for creating new solutions, the solution (e.g., route with planned workloads) with the lowest efficiency metric is utilized to assign the workloads to a driver for a specific route.

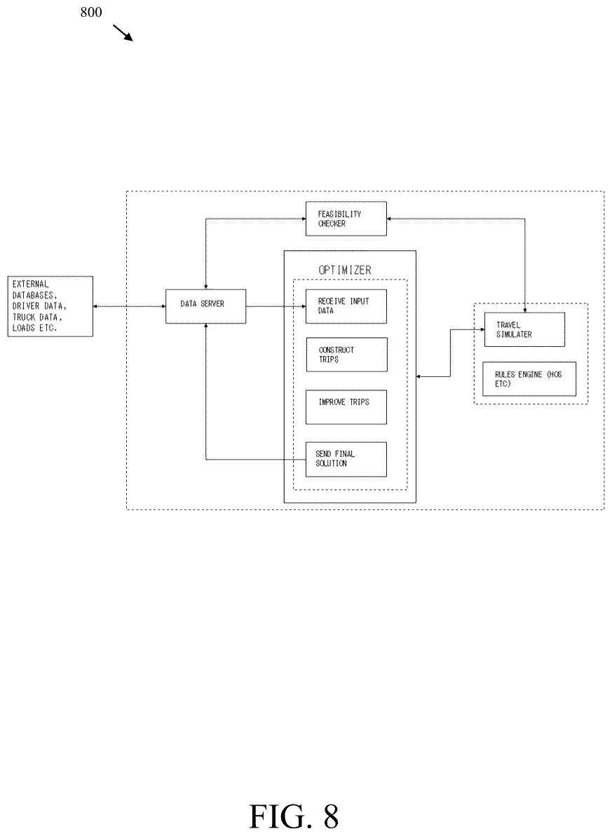

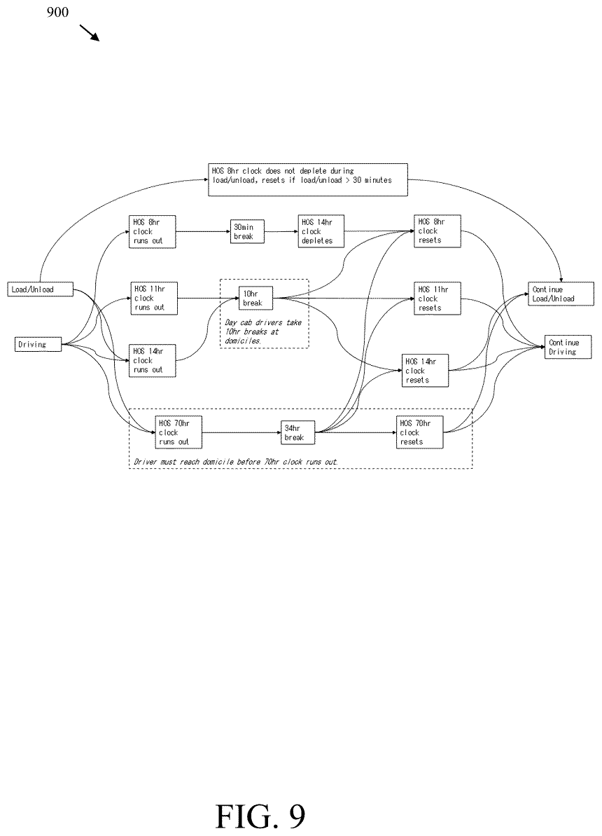

FIG. 8 illustrates an exemplary system architecture 800 according to embodiments disclosed herein. In some embodiments, the optimizer can implement method 400. In some embodiment, the travel simulator can include building a simulation model based on the workload information, the driver information, and the one or more constraints corresponding to the driver with the respective efficiency metric that satisfies the efficiency metric threshold. For example, the travel simulator can simulate a drivers route based on the output from the optimizer. The simulator can simulate the driver's route based on hours of service (HOS) rules, time windows (e.g., load time, unload time, wait time, etc.) and other constraints. In some embodiments, the HOS rules can include at least one of the following: 1) eight hour clock, eleven hour clock, fourteen hour clock, and seventy hour clock. In some embodiments, the eight hour clock includes that after 8 hours of driving, driver must take a 30 minute break. This does not apply to loading/unloading (reset if loading/unloading is greater than 30 minutes). In some embodiments, the eleven hour clock includes that after 11 hours of driving a driver must take a 10 hour break. This is a driving clock and does not apply to loading/unloading time. In some embodiments, the fourteen hour clock includes that after 14 hours the driver must take a 10 hour break. In some embodiments, the seventy hour clock includes that after a driver can perform a maximum of 70 hours on duty within an eight day time window. This requires 34 hours of rest to reset this clock and applies to loading/unloading. FIG. 9 illustrates an example diagram 900 showing the connection between the eight hour clock, eleven hour clock, fourteen hour clock, and seventy hour clock.

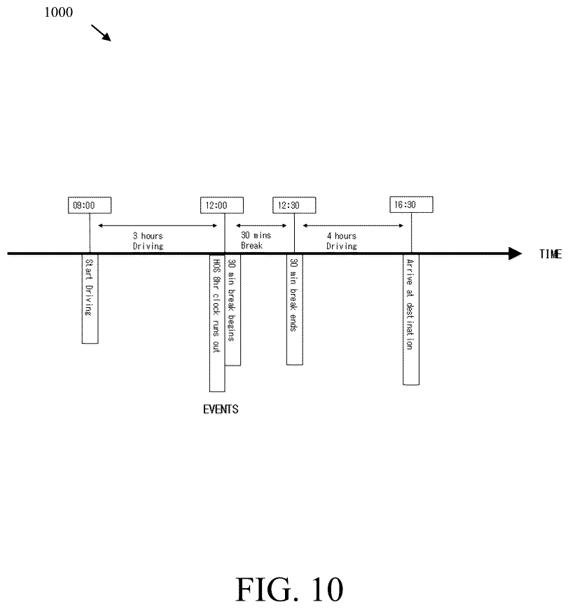

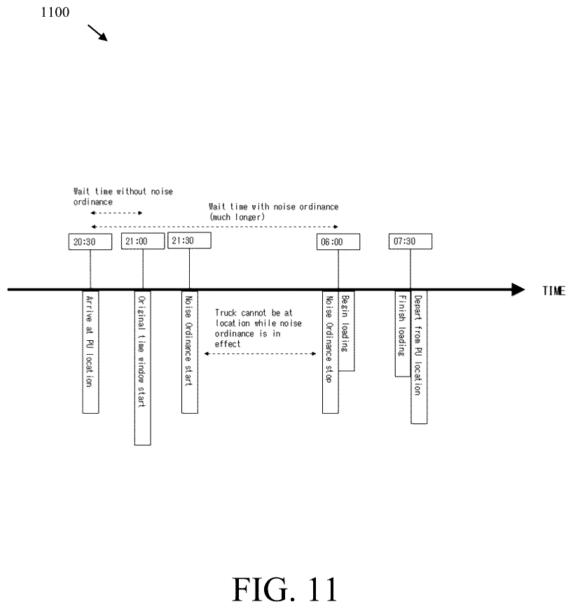

Returning to FIG. 8, in some embodiments, the travel simulator simulates the driver's route from one stop to another. The travel simulator can obtain realistic distances for the destinations based on Haversine formula or can utilize Department of Transportation (DOT) guidelines for air miles. The travel simulator can also assume an average speed for the truck. In some embodiments, the travel simulator is a discrete-event simulation model that can keep track of simulated time, HOS clocks, truck activities and can determine what the next event would be and advances the simulated time to that event. For example, FIG. 10 illustrates a first example output 1000 of the travel simulator. In the illustrated embodiment of FIG. 10, the driver's eight hour clock has 3 hours remaining and the destination requires a total of 7 hours of drive time. As shown in the illustrated example, the driver will need to take a 30 minute break before completing the drive to the destination. FIG. 11 illustrates a second example output 1100 of the travel simulator. In this illustrated embodiment of FIG. 11, a noise ordinance is in place at the destination and the drive will now have to wait until the following day to deliver the workload.

Returning to FIG. 8, based on the outputs of the travel simulator, a feasibility checker can determine if the simulated route is feasible. In some embodiments, the feasibility checker can analyze costs and other key performance indicators to ensure that workloads are delivered on time. For example, in the second output 1100 (FIG. 11) the feasibility checker can determine that this route is not feasible because the workload needs to be delivered before the noise ordinance starts. In this embodiment, the feasibility checker can send instructions to the optimizer to re-compute the route based on method 400 (FIG. 4) and the travel simulator can prepare a simulated route for the feasibility checker to analyze. In some embodiments, the feasibility checker can be implemented by an operator. For example, an operator can input manual routes and override the optimizer and travel simulator. In some embodiments, when the feasibility checker determines that the route for the workload and driver combination, the simulation model can assign the workload to the driver to reduce driver workload waste based on the output of the simulation model satisfying a feasibility checker threshold.

Returning to FIG. 3, in several embodiments, communication system 311 can at least partially perform activity 410 (FIG. 4), and/or activity 450 (FIG. 4).

In several embodiments, evaluation system 312 can at least partially perform activity 420 (FIG. 4), and/or activity 430 (FIG. 4).

In a number of embodiments, analysis system 313 can at least partially perform activity 440 (FIG. 4).

In a number of embodiments, web server 320 can at least partially perform method 400.

In a number of embodiments, the techniques described herein can allow for the more efficient delivery of goods. For example, the embodiments described herein may allow for a reduction in the time required to deliver goods to a customer. Additionally, the embodiments described herein may allow for a reduction in the costs associated with delivering the goods to a customer. For example, the amount of miles driven by delivery trucks with little or no cargo (e.g., “empty miles”) may be reduced, thus reducing delivery vehicle costs, such as fuel costs.

Moreover, the techniques described herein can solve a technical problem that cannot be solved outside the context of computer networks. Specifically, the techniques described herein cannot be used outside the context of computer networks, in view of a lack of data, and because the route optimization engine cannot be performed without a computer.

In many embodiments, the techniques described herein can provide a practical application and several technological improvements. In some embodiments, the techniques described herein can provide an automatic determination of route for a workload by using a predictive model approach focusing on an efficiency metric based on at least a machine learning approach. These techniques described herein can provide a significant improvement over conventional approaches of subjectively searching for route for a workload that can expend a lot of time and computer resources, processors, and memory, to find each previously ordered item in a website (e.g., content catalog of webpages).

Further the techniques described herein can advantageously enable real-time data processing and increase the capability to determine an efficient route for a workload.

In many embodiments, the techniques described herein can be used regularly (e.g., hourly, daily, etc.) at a scale that cannot be handled using manual techniques. For example, the system tracks every workload and driver that can result in a number that can exceed one hundred million data points.

Although systems and methods for route optimization have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform:
receiving workload information corresponding to a workload, driver information corresponding to drivers, and one or more constraints;
building a coordinate system based on the workload information, the driver information and the one or more constraints;
analyzing the coordinate system to determine a respective efficiency metric for each driver of the drivers for the workload;
identifying a driver of the drivers in which the respective efficiency metric for the driver satisfies an efficiency metric threshold; and
assigning the workload to the driver to reduce driver workload waste.

2. The system of claim 1, wherein the workload information comprises:
delivery information corresponding to when the workload needs to be delivered to a distribution center or a vendor; and
a type of workload corresponding to at least one of the following: grocery, dry, pharmacy, third party, or federal emergency aid.

3. The system of claim 1, wherein the driver information comprises at least one of the following:
a driver type corresponding to at least one of the following: day-cab, weekly, or city; and
events associated with the driver, the events comprising at least one of the following: training events, or personal events.

4. The system of claim 1, wherein the one or more constraints comprise at least one of the following: one or more drivers' union rules, local ordinance rules, and location exceptions for the workload.

5. The system of claim 1, wherein building the coordinate system further comprises:
analyzing the workload information, the driver information, and the one or more constraints; and
mapping the workload information, the driver information, and the one or more constraints in a three-dimensional grid corresponding to latitude in a y-axis of the three-dimensional grid, longitude in a x-axis of the three-dimensional grid, and time in a z-axis of the three-dimensional grid.

6. The system of claim 1, wherein analyzing the coordinate system to determine the respective efficiency metric for each driver of the drivers for the workload further comprises:
identifying a threshold distance for the workload in the coordinate system; and
determining the respective efficiency metric for each driver of the drivers for the workload based on:
$$U ( w ) + P ( w ) + ( D ( w ) + W ( w ) + L ( w ) ) ,$$
where w corresponds to the workload, U(w) corresponds to an urgency of the workload, P(w) corresponds to a priority of the workload, D(w) corresponds to empty miles for each driver of the drivers picking up the workload compared to a current route, W(w) corresponds to a value based on a wait time for the workload on each driver of the drivers and a cost per minute of waiting corresponding to the workload, and L(w) corresponds to a value based on a time beyond a scheduled time of delivery for the workload and a cost per minute of being late for to the workload.

7. The system of claim 6, wherein analyzing the coordinate system to determine the respective efficiency metric for each driver of the drivers for to the workload further comprises:
analyzing the respective efficiency metric for each driver of the drivers for the workload by determining a regret metric using the following equation:
$$R ( w ) = {n}^{*} max ( C ( w , d ) ) - sum of top n ( C ( w , d ) ) ,$$
where R(w) corresponds to a regret metric for the workload, d corresponds to a current driver being analyzed, and C(w, d)=D(w)+W(w)+L(w).

8. The system of claim 7, wherein determining the respective efficiency metric further comprises determining the respective efficiency metric based on the regret metric using the following equation:
$$C ( w ) = R ( w ) + U ( w ) + P ( w ) .$$

9. The system of claim 8, wherein the efficiency metric threshold is a lowest value from among the respective efficiency metrics for the drivers.

10. The system of claim 1, wherein executing the computing instructions cause the one or more processors to perform:
building a simulation model based on the workload information, the driver information, and the one or more constraints corresponding to the driver with the respective efficiency metric that satisfies the efficiency metric threshold; and
assigning the workload to the driver to reduce driver workload waste when an output of the simulation model satisfies a threshold.

11. A method implemented via execution of computing instructions configured to run at one or more processors and configured to be stored at non-transitory computer-readable media, the method comprising:
receiving workload information corresponding to a workload, driver information corresponding to drivers, and one or more constraints;
building a coordinate system based on the workload information, the driver information and the one or more constraints;
analyzing the coordinate system to determine a respective efficiency metric for each driver of the drivers for the workload;
identifying a driver of the drivers in which the respective efficiency metric for the driver satisfies an efficiency metric threshold; and
assigning the workload to the driver to reduce driver workload waste.

12. The method of claim 11, wherein the workload information comprises:
delivery information corresponding to when the workload needs to be delivered to a distribution center or a vendor; and
a type of workload corresponding to at least one of the following: grocery, dry, pharmacy, third party, or federal emergency aid.

13. The method of claim 11, wherein the driver information comprises at least one of the following:
a driver type corresponding to at least one of the following: day-cab, weekly, or city; and
events associated with the driver, the events comprising at least one of the following: training events, or personal events.

14. The method of claim 11, wherein the one or more constraints comprise at least one of the following: one or more drivers' union rules, local ordinance rules, and location exceptions for the workload.

15. The method of claim 11, wherein building the coordinate system further comprises:
analyzing the workload information, the driver information, and the one or more constraints; and
mapping the workload information, the driver information, and the one or more constraints in a three-dimensional grid corresponding to latitude in a y-axis of the three-dimensional grid, longitude in a x-axis of the three-dimensional grid, and time in a z-axis of the three-dimensional grid.

16. The method of claim 11, wherein analyzing the coordinate system to determine the respective efficiency metric for each driver of the drivers for the workload further comprises:
identifying a threshold distance for the workload in the coordinate system; and
determining the respective efficiency metric for each driver of the drivers for the workload based on:
$$U ( w ) + P ( w ) + ( D ( w ) + W ( w ) + L ( w ) ) ,$$
where w corresponds to the workload, U(w) corresponds to an urgency of the workload, P(w) corresponds to a priority of the workload, D(w) corresponds to empty miles for each driver of the drivers picking up the workload compared to a current route, W(w) corresponds to a value based on a wait time for the workload on each driver of the drivers and a cost per minute of waiting corresponding to the workload, and L(w) corresponds to a value based on a time beyond a scheduled time of delivery for the workload and a cost per minute of being late for to the workload.

17. The method of claim 16, wherein analyzing the coordinate system to determine the respective efficiency metric for each driver of the drivers for to the workload further comprises:
analyzing the respective efficiency metric for each driver of the drivers for the workload by determining a regret metric using the following equation:
$$R ( w ) = n * max ( C ( w , d ) ) - sum of top n ( C ( w , d ) ) ,$$
where R(w) corresponds to a regret metric for the workload, d corresponds to a current driver being analyzed, and C(w, d)=D(w)+W(w)+L(w).

18. The method of claim 17, wherein determining the respective efficiency metric further comprises determining the respective efficiency metric based on the regret metric using the following equation:
$$C ( w ) = R ( w ) + U ( w ) + P ( w ) .$$

19. The method of claim 18, wherein the efficiency metric threshold is a lowest value from among the respective efficiency metrics for the drivers.

20. The method of claim 11, further comprising:
building a simulation model based on the workload information, the driver information, and the one or more constraints corresponding to the driver with the respective efficiency metric that satisfies the efficiency metric threshold; and
assigning the workload to the driver to reduce driver workload waste when an output of the simulation model satisfies a threshold.
